(19) United States
(12) Patent Application Publication
(10) Pub. No.: US 2003/0030592 A1
(43) Pub. Date: Feb. 13, 2003

(54) Method and system for improving the quality of reception of communications via cellular telephone headset

(76) Inventor: Scott Coloney, Tompkins Cove, NY (US)

Correspondence Address: L. Lawton Rogers, III, 1667 K. Street, N.W., Suite 700, Washington, DC, 20006, US

(21) Appl. No.: 10/187,173

(22) Filed: Jul. 2, 2002

Related U.S. Application Data
(63) Continuation-in-part of application No. 09/794,020, filed on Feb. 28, 2001.
Application No. 09/794,020 is a continuation-in-part of application No. 09/765,273, filed on Jan. 22, 2001.

(51) Int. Cl. H01Q 1/52; H01Q 1/00; H01Q 1/24

(52) U.S. Cl. 343/841; 343/787; 343/702

(57) ABSTRACT

A method and system for improving the quality of reception of communications via cellular telephone headset in which the lead between the cellular telephone handset and the speaker associated with the headset are shielded by a radiation absorbing material thereby reducing interference from electromagnetic emissions in the atmosphere to which the lead is exposed. The conventional electrical connections between the cellular telephone handset and the speaker associated with the headset are desirably coated with a ferrite powder held in place by a suitable conventional wrap and flexible waterproof covering.

### RELATED APPLICATIONS

This application is a continuation-in-part of application Ser. No. 09/794,020 filed Feb. 28, 2001 for Method And System For Shielding The Human Head From Electromagnetic Radiation From Handheld Radio Communications Devices, which is a continuation-in-part of application Ser. No. 09/765,273 filed Jan. 22, 2001 for Electromagnetic Radiation Shielded Headset and Method. The content of these related applications is hereby incorporated herein by reference.

### BACKGROUND OF THE INVENTION

The present application relates to a method and system for improving the reception of communications by the speaker associated with cellular telephones.

Cellular telephones have been in use for a great many years and are in use everywhere today. They are regarded as a necessity by much of humanity, although objectionable to many because of notoriously poor signal quality.

The ambient atmosphere is crowded with electromagnetic signals. In addition to the countless radiowave electromagnetic signals generated by the two-way communications between cellular telephones and the cell sites through which they communicate, the atmosphere in which cellular telephones are used is crowded with electromagnetic radiation emanating from radio and broadcast television stations, from car radios, from taxi and delivery dispatchers, from the microwave ovens found in every sandwich shop and office, from the etc., etc. Great efforts have been made to improve cellular telephone reception by signal processing circuitry designed to reduce the effects of the extraneous electromagnetic energy picked up by the cellular telephone antenna.

Headsets have long been used with land lines and were adopted for use with cellular telephones to free the hands while driving and to thus reduce the risk of automotive accidents. In neither of these applications was the presence of extraneous signals regarded as a problem.

Recently, it is becoming increasingly popular to use headsets with cellular telephones in other than an automotive environment. The cellular telephone is typically worn on the belt or kept in a jacket or shirt pocket. In addition to the convenience of hands free carrying of the cellular telephone, the physical separation of the cellular telephone from the human head is considered by many to reduce the health risks incurred by exposing the human brain to electromagnetic radiation emanating from a source so close to the ear of the user. The speaker is generally worn on or in the ear and is connected thereto the telephone by a line which may include a series-connected microphone at the appropriate distance below the ear and manually operated switch.

This line between the telephone jack and the speaker is generally several feet in length and is exposed to the ambient electromagnetic radiation. Being a conductor, it serves as an antenna and may thus receive signals from any number of diverse sources. These signals, being extraneous to the desired cellular telephone communication, may be superimposed on the line as interference or static downstream of the signal processing circuitry of the cellular telephone for incoming calls, and thus may negatively contribute to the poor reception associated with many cellular telephones. These extraneous signals may also be superimposed on the signal from the transmitter upstream of the cellular telephone and may degrade the signal being processed for transmission by the cellular telephone.

The problem of degradation of cellular telephone reception between the signal processing circuitry in the cellular telephone and the speaker has not been generally recognized and it is accordingly an object of the present invention to provide a novel method and system for improving the reception of signals at the headset speaker of a cellular telephone by decreasing the susceptability to ambient radiation.

In one aspect, this improvement is achieved by the shielding of the line between the cellular telephone and the speaker from the ambient electromagnetic energy downstream of the signal processing circuitry associated with the cellular telephone, and more particularly by the use of an electromagnetic energy absorbing material such as ferrite to effect such shielding.

Shielded electrical lines are in general well known. They have, for example, long been used in electronic laboratories where communications equipment is built and tested. They have also been used for many years in applications in dangerous environments such as dynamite blasting as well as in military applications where premature detonation of armaments is a concern. Typically, such shielding consists of a braided mesh of electrically conductive wire. However, this long known shielding technology has not been applied to cellular telephones despite the long term and continuing dissatisfaction with cellular telephone reception.

The problem of interference exacerbated by the use of cellular telephone headsets with the line between the cellular telephone and the headset speaker. It is accordingly another object of the present invention to provide a novel cellular headset line and method which improves reception by the reduction of interference downstream of the cellular telephone processing circuitry.

These and many other objects and advantages will be apparent to one of skill in this art upon consideration of the detailed description and the appended drawings.

### BRIEF DESCRIPTION OF THE DRAWINGS

FIG. 1 is a line drawing illustrating the use of a cellular telephone headset.

FIG. 2 is a pictorial view of one embodiment of the novel line connecting the speaker and the cellular telephone of FIG. 1

### DESCRIPTION OF THE PREFERRED EMBODIMENTS

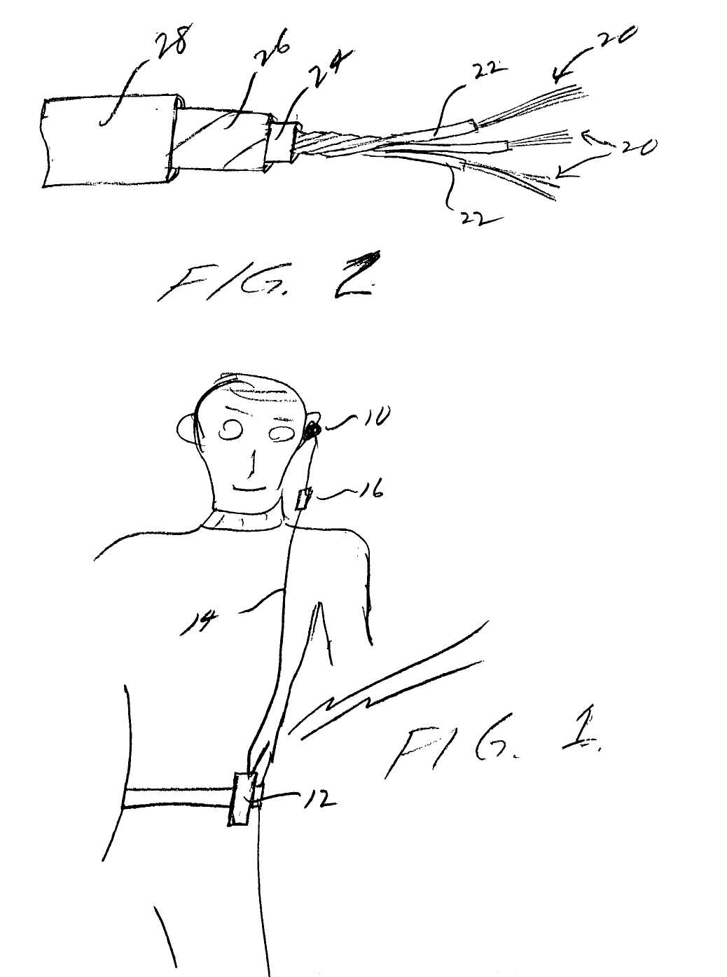

FIG. 1 illustrates one embodiment of a conventionally constructed headset with a speaker 10 carried adjacent the ear and a cellular telephone 12 carried conventionally on the belt. The line 14 intermediate the cellular telephone 12 and speaker 10 includes a microphone 16 spaced appropriately from the speaker in proximity to the mouth of the user.

FIG. 2 shows one embodiment of the novel line 14 of FIG. 1. With reference to FIG. 2, the line 14 may comprise a number of multiple strand wires 20 connected to any switches in the line 14 and conveying audio signals from the cellular telephone 12 to the speaker 10 and from the microphone 16 to the cellular telephone 14 for transmission to the cell site (not shown).

The wires 20 may be conventionally insulated with a layer 22, often by wrapping with distinctively color coded material. The insulated wires may then be encased in an electrically conductive material 24. Where the material 24 is ferrite and in powder form, it has been found desirable to wrap the ferrite coated insulated wires with a suitable tape 26. A final layer of flexible insulation 28 may conventionally be placed over the wrapped ferrite to provide protection from moisture.

The conducting material 24 may be any suitable conventional electromagnetic radiation shielding material such as a metallic fabric or screen, and is desirably flexible and soft to the touch. By way of example, the material may comprise a woven or pressed fabric or mesh made from one or a combination of electrically conducting fibers such as carbon, lead, potassium, steel, or copper.

Alternatively, and preferably, to the use of conductive material, ferrite or other hysteresis affecting material may be used, as a powder or as a coating for fibers or fabric.

The conventionally shaped microphone may be molded of a suitable plastic material in which shielding powder or fibers have been embedded to form a composite material. The presence of this conductive or hysteresis affecting material in a matrix of thermoplastics such as polypropylene, thermoset polymers such as polyamide, reaction molded plastics such as polyurethane, and elastomers such as silicones may also be beneficial.

While preferred embodiments of the present invention have been described, the embodiments described are illustrative only and the scope of the invention is to be defined solely by the appended claims when accorded a full range of equivalents, many variations and modifications naturally occurring to those of skill in the art from a perusal hereof.

What is claimed is:

1. In a headset for a cellular telephone, the improvement including an electromagnetic shielded line between the speaker and the cellular telephone.

2. The improvement of claim 1 wherein said shielding includes ferrite.

3. A cellular telephone headset line comprising:
plural electrically insulated wires;
an inner layer of electromagnetic energy shielding material overlying said wires; and
an outer layer of a flexible insulative and waterproof material overlying said layer of electromagnetic energy shielding material.

4. The cellular telephone headset line of claim 3 wherein said inner layer is electrically conductive.

5. The cellular telephone headset line of claim 3 wherein said inner layer includes a hysteresis affecting material.

6. The cellular telephone headset line of claim 5 wherein said hysteresis affecting material is a ferrite powder.

7. The cellular telephone headset line of claim 6 further including a layer of material overlying said ferrite powder.

8. The cellular telephone headset line of claim 3 wherein said inner layer includes radiation adsorbing material.

9. A method for improving the quality of reception of communications via cellular telephone headset comprising the step of covering the lead between the cellular telephone and the speaker associated with the headset with a radiation absorbing material.

10. A method for improving the quality of reception of communications via cellular telephone headset comprising the step of covering the lead between the cellular telephone and the speaker associated with the headset with an electrically conductive material.

11. A method for improving the quality of reception of communications via cellular telephone headset comprising the step of shielding the lead to the speaker downstream of the signal processing circuits of the cellular telephone.
